(19) United States
(12) Patent Application Publication
(10) Pub. No.: US 2010/0321405 A1
(43) Pub. Date: Dec. 23, 2010

(54) Method and system for dynamically arranging multiple product images in a preconfigured panel on an electronic display

(75) Inventors: Jason E. MacInnes, Watertown, MA (US); Kevin A. Ramos, Attleboro, MA (US); Maura J. McCarthy, Shrewsbury, MA (US)

Correspondence Address: VISTA PRINT USA, INC.;ATTN: PATENT COUNSEL, 95 HAYDEN AVENUE, LEXINGTON, MA, 02421, US

(73) Assignee: VistaPrint Technologies Limited

(21) Appl. No.: 12/489,137

(22) Filed: Jun. 22, 2009

(51) Int. Cl. G09G 5/00

(52) U.S. Cl. 345/635; 345/670

(57) ABSTRACT

Systems and methods that provide automated techniques for dynamically arranging a plurality of product images in a pre-configured panel on an electronic display, wherein the pre-configured panel comprises a static chrome area that must remain fully visible when displayed on the electronic display.

### FIELD OF THE INVENTION

The present invention relates to computer-implemented systems and methods for dynamic product image arrangement and presentation on an electronic display.

### BACKGROUND OF THE INVENTION

In product marketing, vendors of products seek to present images and descriptions of the products in ways that entice customers to purchase the product. In printed catalogs, a vendor may present an image of an offered product along with a product description and ordering details. With the proliferation of web-based retailers, which allow a user to browse and order products from an online vendor of products, online catalogs are also now quite common.

A typical implementation of an online catalog displays thumbnail images of each product along with an associated text description and an ordering active control (such as a link to an order page or common e-commerce cart controls). The layout of the catalog is determined during the design of the web page itself and dictates a standard display arrangement of the products offered in the catalog.

If an online vendor of products desires to offer multiple products together as a kit or bundle of products for a single overall price (such that the items in the kit are not priced individually), the vendor must typically pre-generate a single image containing all of the products in the kit to present as the kit image in the online catalog. While bundling products together into kits for a lower overall price can result in higher product sales, such a marketing strategy may be less attractive to an online vendor of products due to the time and money required in generating the image of the kit (including all of the products that have been bundled together into the kit) and creating a catalog entry for the kitted offer in their online catalog.

In some ecommerce web sites, the ordered products are also displayed when the customer requests to view their cart. These are typically displayed in catalog form, showing a thumbnail image and associated description, price, and quantity of each ordered product.

When a customer orders a product from a vendor, the vendor may wish to promote its other products to the user by presenting images of the other products that may also be of interest to the customer. Arranging images of the proposed other products in an aesthetically pleasing manner may more easily convince the customer of their desire to order the additional products.

In many businesses, branding is a common form of promoting and marketing a business. Successful branding typically requires a multitude of marketing materials, including printed materials such as business cards, letterhead stationery, postcards, magnets, pens, t-shirts and other clothing, as well as non-printed materials such as websites, e-mails, and other electronic media and forms of advertisement. Successful branding is also facilitated when such marketing materials, and also any graphical designs imprinted or otherwise affixed to any products sold by the business (such as labels or tags), convey a coordinated look and feel, such as by affixing a common logo, a common image, common font, and common color scheme, across all products associated with the business or source of the brand.

Many customers of branded products or products having user-customized designs thereon desire to view other design-coordinated products and/or the vendor desires to present such design-coordinated products to the customer for consideration in purchasing the additional products. In these situations, it would also be desirable to have a simplified efficient technique of arranging images of the proposed other products in an aesthetically pleasing manner for display on a customer's display.

### SUMMARY

The present invention is directed to systems and methods that provide automated techniques for dynamically arranging a plurality of product images in a pre-configured panel on an electronic display, wherein the pre-configured panel comprises a static chrome area that must remain fully visible when displayed on the electronic display.

In an embodiment, a computer implemented method includes receiving dimensions of a panel to be displayed on the electronic display, receiving a plurality of images to be displayed in the panel, and obtaining dimensions of each of the images. The method then includes arranging all of the images on the panel at predetermined positions on the panel that do not coincide with the static chrome area of the panel, determining whether any portion of any of the arranged images exceeds the dimensions of the panel or coincides with any portion of the static chrome area of the panel. If it is determined that any of the arranged images exceeds the dimensions of the panel or coincides with any portion of the static chrome of the panel, the method includes the steps of scaling the images to reduce the size of all of the images by a predetermined proportional amount and repeating the arranging step through the scaling step until none of the arranged images exceeds the dimensions of the panel or coincides with any portion of the static chrome of the panel. The method may further generate a set of coordinates associated with each of the respective product images and corresponding to the respective position of the respective arranged image in the panel. The set of coordinates indicate where the respective product image should be placed in the pre-configured panel when displayed on the electronic display. The pre-configured panel and the plurality of product images with the product images anchored in the pre-configured panel at their associated coordinates are displayed on an electronic display.

Other embodiments include computer readable storage medium and apparatuses which implement the method.

It is an advantage of the invention that the workload required prepare and present a plurality of images in an aesthetically pleasing arrangement is significantly reduced.

### BRIEF DESCRIPTION OF THE DRAWINGS

FIG. 1 is a representation of an exemplary embodiment of a pre-configured panel.

FIG. 2 shows a representation of a plurality of product images.

FIG. 3 is a flowchart of an exemplary embodiment of a method for dynamically arranging a plurality of product images in a pre-configured panel on an electronic display.

FIG. 4 is an exemplary pattern and order in which product images are arranged in a panel.

FIG. 5 is a panel with product images arranged therein according to a method of the invention;

FIG. 6 is a system diagram of an embodiment of a system in which the invention may operate;

FIG. 7 is a kit offerings web page;

FIG. 8 is an example product selection web page which allows a customer to configure their own kit.

FIG. 9 is an example panel displaying a set of products in a selected kit, and arranged according to the method of the invention.

### DETAILED DESCRIPTION

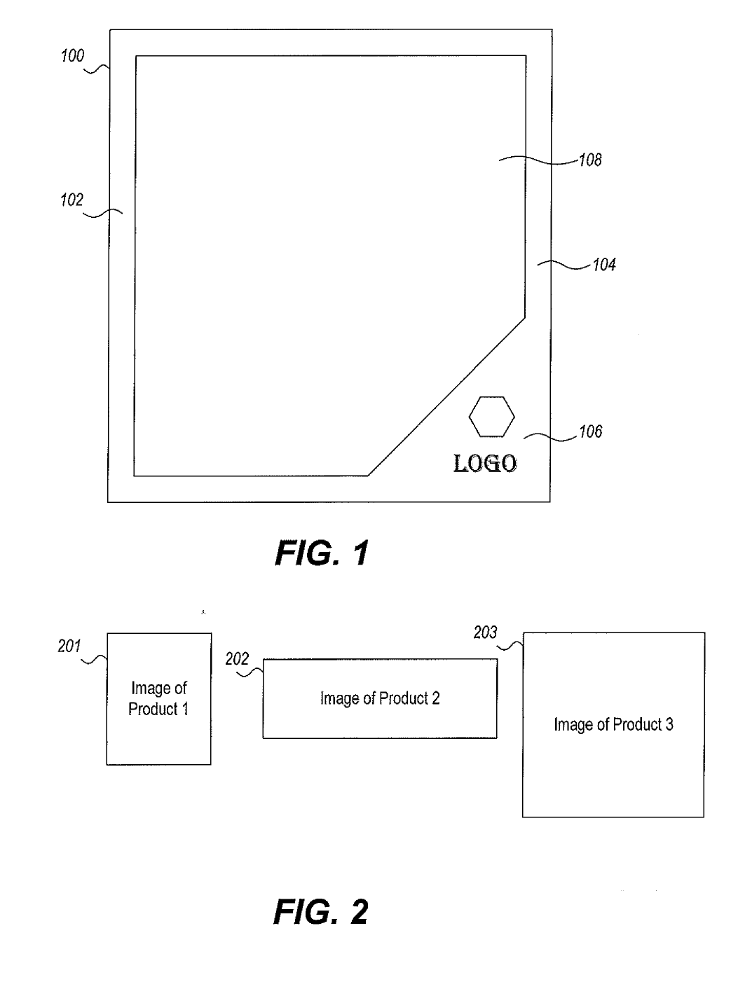

FIG. 1 is an exemplary embodiment of a panel 100 to be displayed on an electronic display. As used herein, a “panel” is an area on a display in which images are displayed, and is typically a subarea displayed within a window of a browser or other graphical user interface. The panel is generally rectangular and has pre-configured dimensions, including a pre-configured height and a pre-configured width. The panel also includes a static artwork area that is considered part of the frame of the panel. The frame visually delineates the panel from the remaining content and portions of the window in which the panel is displayed. The static artwork of the frame remains visible regardless of the content displayed within a display area 108 of the panel framed by the frame 102. In FIG. 1, the frame 102 includes a border 104 of pre-configured height and width (preferably in terms of pixels), and a static artwork area 106. In the illustrative embodiment, the static artwork area is a triangular area in the bottom right-hand corner of the panel and may contain a logo or other static content.

FIG. 2 shows a plurality of product images 201, 202, 203 that a vendor may desire to display together in a panel on a user's electronic display. The particular product images to be displayed may be dynamically selected from a larger set of product images. For example, the vendor's web site may allow the user to select a plurality of different products to purchase together and may then display the selected products in a panel such as panel 100 in FIG. 1.

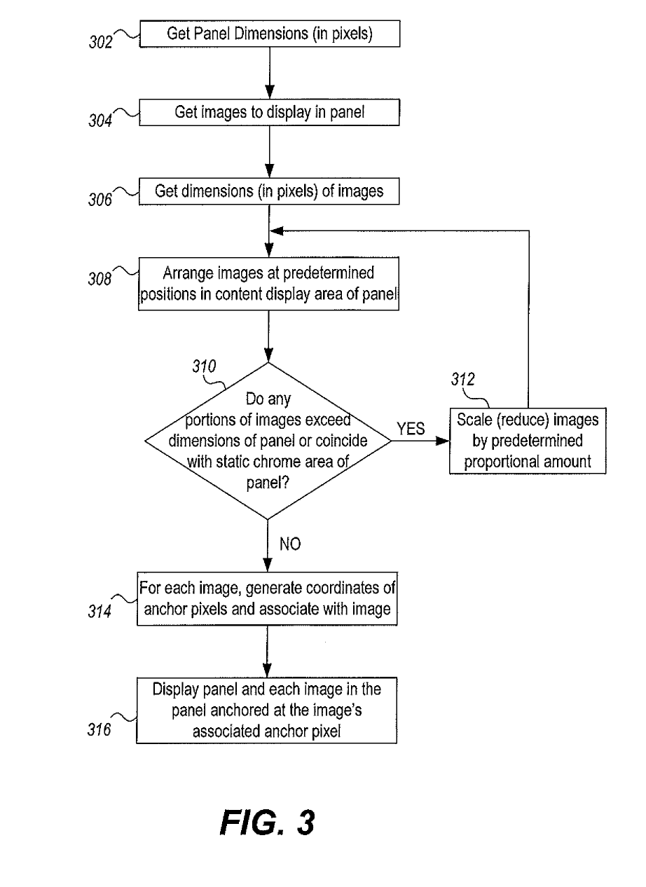

FIG. 3 is a flowchart illustrating an exemplary method for dynamically arranging a plurality of product images in a pre-configured panel on an electronic display, wherein the pre-configured panel comprises a static chrome area that must remain fully visible when displayed on the electronic display. As illustrated, the method includes receiving dimensions of the panel to be displayed on the electronic display. Preferably the dimensions are in terms of pixels on the display. Thus, the panel is configured as x pixels in width and y pixels in height. The method also includes steps for receiving a plurality of images to be displayed in the panel (step 304) and obtaining dimensions of each of the images (step 306). Preferably the dimensions of the images are in terms of pixels. The method then includes a step of arranging all of the received images on the panel at predetermined positions on the panel (step 308). The predetermined positions are pre-configured so that the anchor point (pixel in the panel to which a predetermined point on the image is to map to) does not coincide with the static chrome area of the panel. The method then includes a step of determining whether any portion of any of the arranged images exceeds the dimensions of the panel or coincides with any portion of the static chrome area of the panel (step 310). If it is determined that any of the arranged images exceeds the dimensions of the panel or coincides with any portion of the static chrome of the panel (in step 310), then the method performs a step of scaling the images to reduce the size of all of the images by a predetermined proportional amount (step 312). Steps 308 through 312 are then repeated until none of the arranged images exceeds the dimensions of the panel or coincides with any portion of the static chrome of the panel.

Once the images are arranged and scaled to fit within the dimensions of the panel without overlapping the static chrome area of the panel frame (as determined in step 310), for each of the plurality of images, a set of coordinates corresponding to an anchor pixel to which the image is to be anchored in the panel is associated with the respective product image (step 314). Then, when the images are to be displayed in the panel, the panel and the plurality of product images are positioned in the pre-configured panel such that a predetermined product image pixel is anchored at the panel pixel corresponding to the image's associated anchor pixel coordinates.

The steps of the method for one embodiment are described now in more detail. First, the following information is received, obtained, or otherwise determined:
1) A set of products that is to be rendered within the panel
2) The dimensions of the final panel, in pixels
3) The maximum allowed width of any given product image, in pixels, in the panel.

This width is specified by the client of the collage algorithm.

Second, the dimensions of each of the product images are determined. This is accomplished by:
1) Receiving, obtaining, or otherwise determining the native dimensions, in pixels, for each product. The native dimensions of a product are the largest width and height, in pixels, that the image can be displayed on an electronic display without pixilation occurring. For a printed product, to ensure high print quality, these dimensions are very large. The algorithm only uses these dimensions to determine the scale of the product images relative to one another.
2) Sorting all of the product images that are being rendered by their native width.
3) Using the product image with the largest width in the set determining an amount of reduction in scale that needs to be applied to the products. In one embodiment the scale is determined by the following formula: scale=maximum allowed width/largest native width
4) If the scale is less than 1 the dimensions of every product that in the set may be multiplied by the scale to normalize the product image size to 1.

Third, the algorithm arranges the previews within the panel. The algorithm uses the following rules:
1) Previews are sorted by the height as determined in two dimensions.
2) Product images cannot go outside the bounds of the panel.
3) Product images cannot overlap the static chrome area (for example, the static chrome area in the bottom right triangle of the panel 100).
4) In the illustrative embodiment the position of the right chrome is assumed to be a triangle shaped image in the bottom right corner with predefined dimensions (in pixels).
5) If during the course of arranging each of the product images, either of the previous two rules is violated, the dimensions of all the product images are reduced by 5% and then the arrangement step is performed again.
6) Product images are placed in the collage panel in a pyramid-like shape:
   a. The method starts by placing the tallest product image at the top of the pyramid. The top of the pyramid is labeled level 1.
   b. Each subsequent level gets one more product image placed in it than the previous level. Within a level, product image are placed left to right. A certain amount of padding is placed within each product image. The amount of padding is configurable. The pyramid will have as many levels needed to place all of the product images within the collage.
   c. Subsequent levels can overlap the bottom of the previous level by a percent of the total height of the previous level. The allowable overlap percent is configurable. This is accomplished by putting lower levels on a higher layer than the previous level.
   d. The entire width of each level is centered within the panel—adjusting for any overlap with the bottom right corner chrome.
   e. Each preview on a level has the same baseline. This means the bottom of every preview on a level is aligned.
7) The output of the algorithm is a list of the products being previewed along with a set of coordinates where each product should be placed. The coordinates represent the horizontal and vertical distance from the top left corner of the collage panel.
8) The product images are then displayed to the user using the coordinates and CSS (Cascading Style Sheets) absolute positioning (a standard client side browser technology)

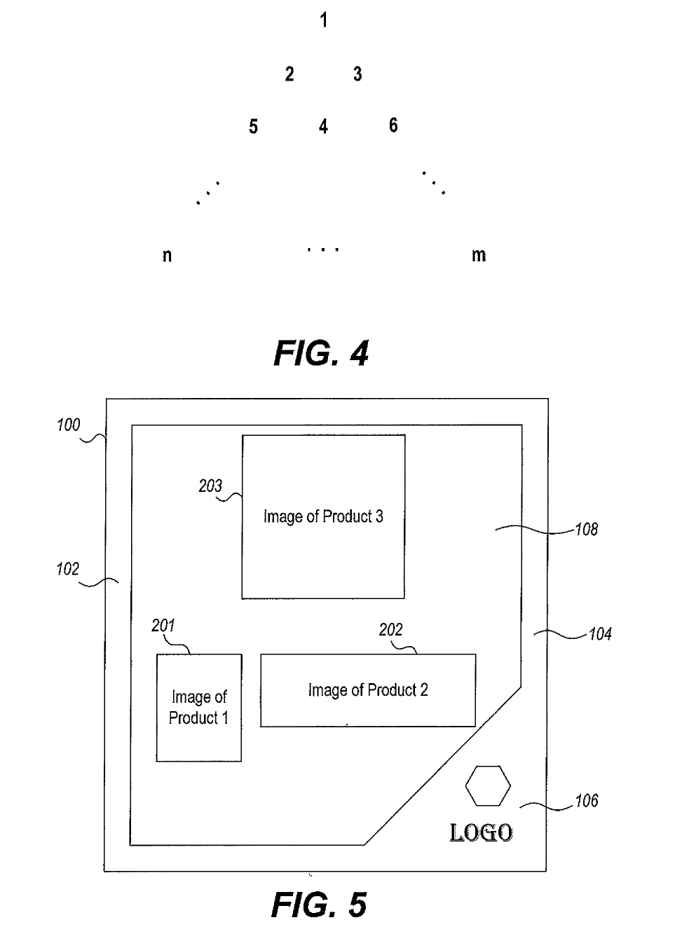

Thus, in one exemplary embodiment, the matching customized product images are arranged in a sort-of “bowling pin” or pyramid arrangement, as illustrated in FIG. 4. In this embodiment, the product images are sorted by height of image of product (where “1” in FIG. 13 is the image having the greatest height, “2” is the image having the next greatest height, “3 is the image having the next greatest height and so on). The product images are sorted, and then arranged as shown in FIG. 4 according to height. Thus, the image having the greatest height is anchored in the position “1” at the top of the pyramid in the content area of the panel and is assigned a z-index value placing the image at position “1” at the back layer. The image having the next greatest height is anchored on the left position “2” on the next level of the pyramid and assigned a z-index placing the image at position “2” just in front of the z-index layer of image “1”. The image having the next greatest height is anchored on the left position “3” on the next level of the pyramid and assigned a z-index placing the image just in front of the z-index layer of image at position “1”. The image having the next greatest height is anchored on the left position “4” on the next level of the pyramid and assigned a z-index placing the image just in front of the z-index layer of image at positions “2” and “3”. The placement continues in a like fashion, whereby images may be continued to be added to the panel, growing from the top down. The z-index value associated with each image “1” through “n”, is incremented for each level of the pyramid.

The size of the products in the montage are preferably the “natural preview size” of the products, whereby given an image container, the product size within the image occupies as much of the image container as possible without distorting or cropping the product in the image. Smaller products may appear larger relative to larger actual products because larger products may be “capped” such that they are drawn smaller than actual relative size in the panel. To achieve a balanced appearance in the panel, one or more of the respective product images may be resized to a different size such that the resized product image is not representative of the respective size of the corresponding actual product relative to the sizes of the actual products corresponding to the non-resized product images.

FIG. 5 illustrates the panel 100 after the method 300 has dynamically arranged the images 201, 202, 203 into the panel.

The method described above may be implemented in a computer system that includes at least an electronic display, one or more processors, computer readable storage and data memory, and program instructions that implement the method. One use of the technique is in connection with an online retailer website that allows users to select a plurality of different products as a kit for one overall price. Typically the price will be less than the cumulative retail price of the individual items when purchased individually. The online retailer pre-configures kits of different products, or alternatively allows the customer to select products to go into a kit, and then presents an image of the contents of the selected kit in a panel such as illustrated in FIG. 5.

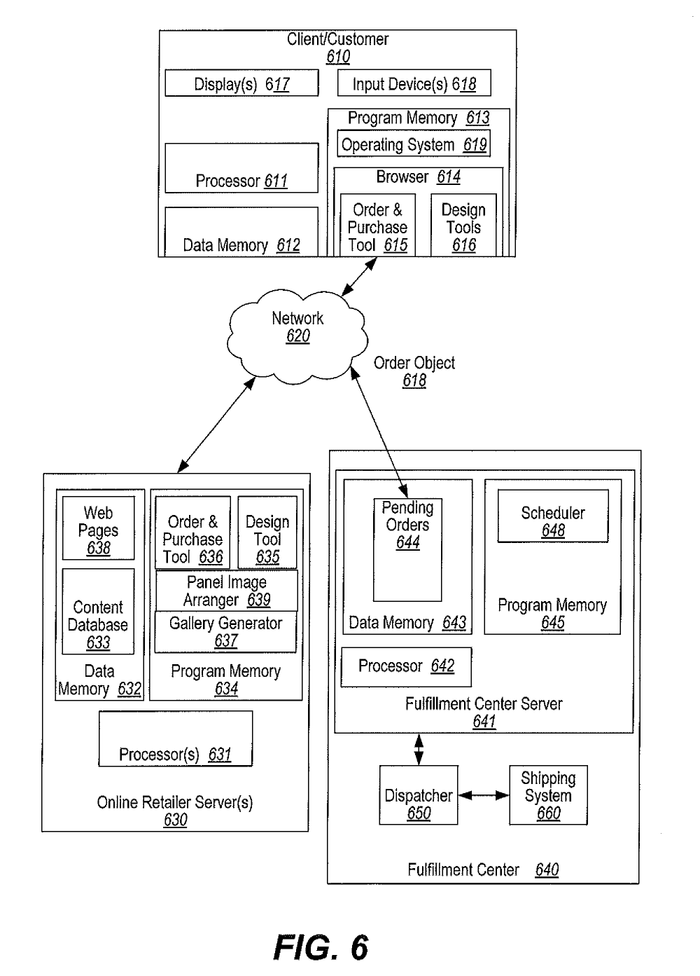

Turning now in detail to the various embodiments of the invention, FIG. 6 is a block diagram of an exemplary system 600 in which embodiments of the invention operate. As illustrated, a client computer system 610 being used by a customer or other user connects via a network 620 to the website of an online vendor hosted on one or more server(s) 630 configured to communicate and operate cooperatively, referred to hereinafter as “server 630”. The server 630 serves web pages 638 to a browser 614 executing in the client computer's program memory 613 under the control of the processor 611 of the client computer 610. The web pages 638 display items available for ordering by the customer browsing the website. Design tool(s) 616/635 may execute in the client computer browser 614 and/or at the website server 630 to allow the customer to select options for products being ordered and/or to create customized designs for printing on, or otherwise manufacturing, an item being ordered. Order and Purchase tool(s) 615/636 execute in the client computer browser 614 and/or at the server 630 to allow the customer to complete an order and make payment arrangements.

A Fulfillment Center 640 receives completed orders, and retrieves or manufactures the items specified in the order, and ships, delivers, or makes available for pick-up the fulfilled order. In the embodiment illustrated, the Order and Purchase tool(s) 615/636 generate an order object 618, which is transmitted over a network 620 such as the Internet or via a direct connection, to a Fulfillment Center server 641. The order object 618 preferably includes information such as a customer ID, a shipping address, item(s) ordered and associated quantities of ordered items, and other information required by the Fulfillment Center 640 to fulfill the order. The Fulfillment Center server 641 comprises one or more processors 642 connected to the network 620 to receive order objects 618 to process and fulfill. Order objects 618 are stored in pending orders database 644 in data memory 643 until processed by a scheduler 648 executing in program memory 645. The scheduler 648 instructs a dispatcher 650 to fulfill the order by collecting and/or manufacturing all of the items specified in the order object 618. Alternatively, an order specified in an order object 618 may be split into multiple partial orders that may be fulfilled separately. Once an order or partial order has been fulfilled, it may be passed to a shipping system 660 for shipment to the customer. Alternatively, the fulfilled order or partial order may be made available for pickup by the customer or a delivery agent. An exemplary online retailing system and Fulfillment Center is a print job management system of an online printed products vendor, many of the details of which are described in each of U.S. Pat. No. 6,650,433, entitled “Managing Print Jobs”, U.S. Pat. Pub. No. 2008/0080006 A1, entitled “Preparation of Aggregate Jobs for Production”, and U.S. Pat. App. No. 2008/0080006 A1, entitled “Order Aggregation System And Method”, each of which are hereby incorporated by reference in their entirety.

The client computer system 610 includes one or more processor(s) 611 and program and data memory 612, 613. Memory 612, 613 stores computer-readable instructions and data, and may be embodied in any one or more computer-readable storage media of one or more types, such as but not limited to RAM, ROM, hard disk drives, optical drives, CD-ROMs, floppy disks, memory sticks, etc. Memory 612, 613 may include permanent storage, removable storage, and cache storage. In a preferred embodiment, client computer system 610 is a typically equipped personal computer, portable computer, tablet computer or other computer device. The user views images from client computer system 610 on one or more displays 617, such as a CRT or LCD screen, and provides inputs to client computer system 610 via input device(s) 618, such as a keyboard and a mouse.

When client computer system 610 is operating, an instance of the client computer system 610 operating system will be running, represented in FIG. 6 by Operating System 619. In addition, the user may be running one or more application programs. In FIG. 6, client computer system 610 is running Web browser 614, such as Internet Explorer from Microsoft Corporation. In the exemplary embodiment, design tool(s) 616 include one or more product design program(s) downloaded to client computer system 610 via network 620 from the online vendor server 630. Design tool(s) 616 may run in browser 614 or alternatively could be installed in program memory 613. In an embodiment, design tool(s) 616 allow the user to prepare a customized product design in electronic form. In an embodiment, when the customer is satisfied with the design of the product, the design can be uploaded to server 630 for storage and subsequent production of the desired quantity of the physical product on appropriate printing and post-print processing systems. As will be discussed in more detail below, the user creates a custom product design by customizing a template provided by the service provider and adding the user's content.

Server 630 includes program memory 634 and data memory 632. Memory 634, 632 stores computer-readable instructions and data, and may be embodied in any one or more computer-readable storage media of one or more types, such as but not limited to RAM, ROM, hard disk drives, optical drives, disk arrays, CD-ROMs, floppy disks, memory sticks, etc. Memory 634, 632 may include permanent storage, removable storage, and cache storage. Data memory 632 may comprise one contiguous physical computer readable storage medium, or may be distributed across multiple physical computer readable storage media, which may include one or more different types of media. Data memory 632 stores web pages 638, typically in HTML or other web-language format to be served to client computers 610 and displayed in client browsers 614. Data memory 632 also includes a content database 633 that stores content such as various layouts, patterns designs, color schemes, font schemes and other information used by the server 630 to enable the creation and rendering of product templates and images. Co-owned U.S. Pat. No. 7,322,007 entitled “Electronic Document Modification”, and U.S. Pat. Publication No. 2005/0075746 A1 entitled “Electronic Product Design”, each describes a Web-based document editing system and method using separately selectable layouts, designs, color schemes, and font schemes, and each is hereby incorporated by reference in its entirety into this application.

Server 630 utilizes a gallery generator 637 which selects and assembles content from the content database 633 to generate a gallery of images of products for display on the display 617 of a client computer 610 to a given customer. As is described in greater detail in copending application UNKNOWN, filed Jun. 22, 2009, entitled “METHOD AND SYSTEM FOR DYNAMICALLY GENERATING A GALLERY OF IMAGES OF AVAILABLE DESIGNS FOR KIT CONFIGURATION”, which is hereby incorporated by reference in its entirety, the gallery generator 637 determines which designs can be offered for a selected configuration. In an embodiment, the gallery generator 637 is implemented as program instructions residing in program memory 634 of the server 630.

When a customer navigates to the website of the online vendor, the server 630 serves a series of web pages 638 to the client's browser 614. The web pages 638 include pages to display images of products available for order from the vendor, pages to receive the customer's product and product option/design selections, and pages to receive payment for ordered products.

Often, it is desirable to bundle together multiple different products into a kit and offer the kit to a customer at a single price. For example, a vendor of products may offer kits to assist the customer in performing a particular project or achieving a particular goal, the performance or achievement of which requires or utilizes all of the prods in the kit. As another example, a vendor may bundle several products into a kit in the hopes of selling more products. In this example, in order to entice the customer to purchase more products, the vendor may set the price of the kit to be lower than the price would otherwise be if the customer were to order each product in the kit individually. Also, it may be desired to select products that are related in some manner so that the customer is more likely to purchase the bundle of different products rather than just the original product that they may have been interested in. For example, a customer ordering business cards may be more easily enticed to buy other business-related products such as business letterhead, envelopes, return address labels, pens and other business promotional products. In addition, when bundling different products together, it may be further desirable to bundle products that have a common design feature. For example, a vendor of a variety of different business products having a variety of different design features may want to bundle together only those different products that have a closely matching design feature in order to present a bundled kit of coordinated products. Thus, a typical customer of the vendor of business products might be a business owner purchasing business cards. Presumably, if the customer were to be presented with a kit offering that included business cards and other products, for example, return address labels, postcards, brochures, t-shirts, mouse pads, and/or other promotional products, the customer would prefer to purchase products that have one or more closely matching graphical design features printed or otherwise applied on each of the products in order to present a coordinated brand or look-and-feel to the products used in marketing the business.

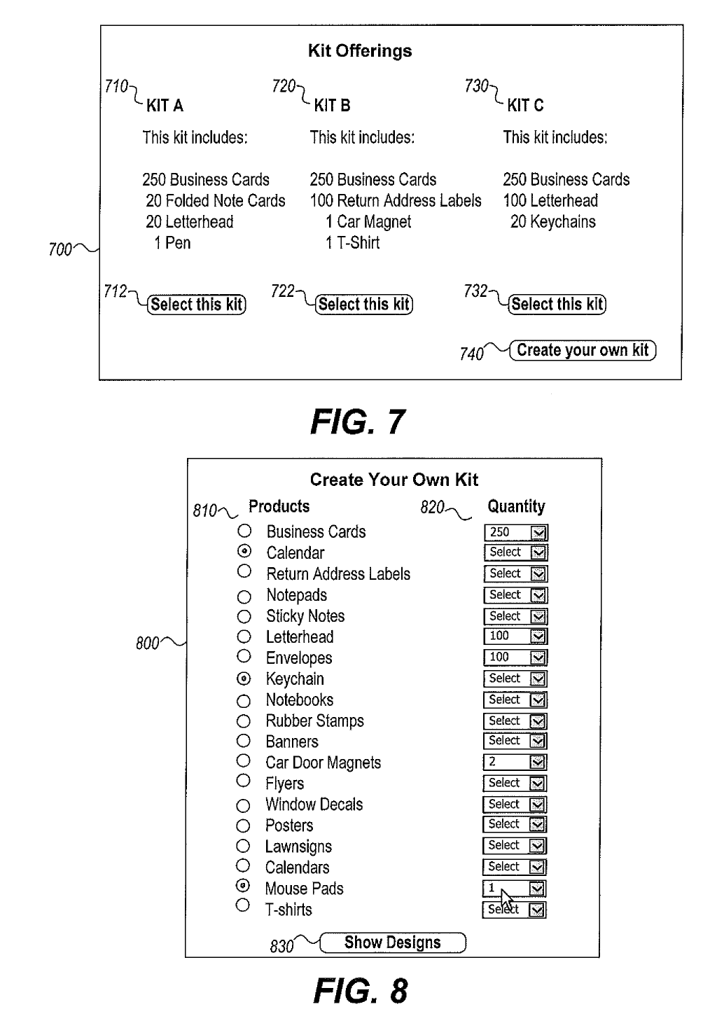

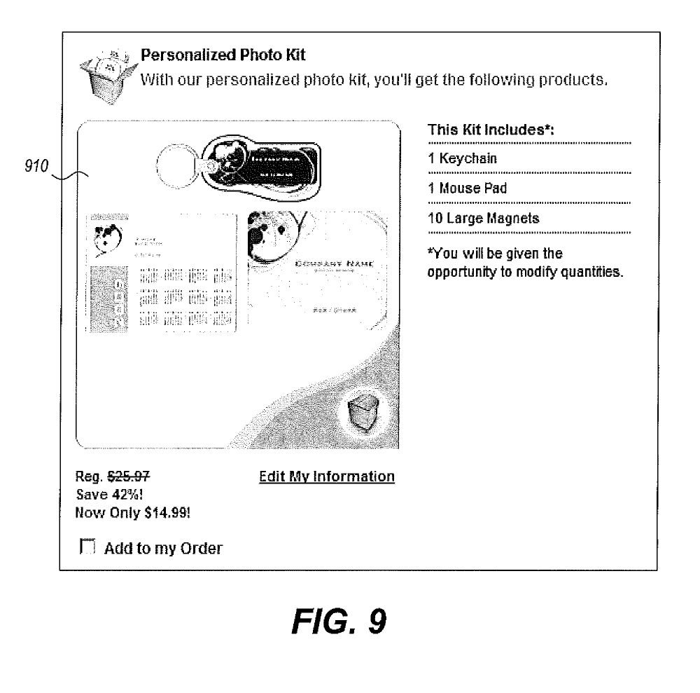

FIG. 7 is an exemplary web page of an online retailer. The customer may navigate to, or land on, the kit offering web page 700 via various different web navigation paths. In the illustrated embodiment, the kit offering web page 700 displays and promotes various types of kit offerings available from the online vendor and offers active controls that allow the customer to select a desired kit offering for a more detailed presentation of design options. By way of example, FIG. 7 shows promotions for various bundled kit offerings, such as Kit A 710, Kit B 720, and Kit C 730, each of which offers a different combination of different products that can be purchased together at a single lower overall price. Each kit offering 710, 720, 730 has associated therewith an active control 712, 722, 732 such as a link or button, which when activated indicates to the server 630 that the customer has selected the associated kit offering. Selection by the customer of one of the active controls 712, 722, 732 triggers the gallery generator 637 to dynamically determine and display the available designs for the selected kit configuration.

Alternatively, or in addition, the vendor may allow a customer to configure their own set of products to be bundled into a kit. For example, an online vendor may provide a kit customization web page in the kit path, such as shown in FIG. 5. This web page may be navigated to by means of various paths. By way of example only and not limitation, a “Create your own kit” button 740 may be provided on other web pages, such as the kit offerings web page 700 of FIG. 7. As illustrated in FIG. 8, the product selection web page 800 includes a list of available products 810 that may be selected and combined with other selected products into a kit. Associated with each product description is a selector control (such as a radio button as shown) and a quantity selector (such as a drop-down menu of possible quantities as shown). The product selection page allows the user to select the various products and associated quantities 820 that the user desires to combine into a kit of matching products. Upon completion of the desired product and quantity selections, the user clicks on a “Show Designs” button 830, which triggers the gallery generator 837 to dynamically determine and display the available designs for the selected kit configuration.

In a subsequent web page, images of the products in the selected kit are displayed together in a panel 910 implemented according to the method described with respect to FIGS. 1-5. A panel image arranger 639 (FIG. 6) receives the selected products in the kit, and the panel dimensions, and generates the anchor pixel coordinates for each of the product images. The panel image arranger 639 sends the anchor pixel coordinates to the customer's computer, which uses Cascading Style Sheets absolute positioning to place the product images in the panel 910 on the customer's display screen.

While the invention has been described in various exemplary embodiments, the described embodiments are to be considered as illustrative rather than restrictive. The scope of the invention, therefore, is as indicated in the following claims and all equivalent methods and systems.

What is claimed is:

1. A computer implemented method for dynamically arranging a plurality of product images in a pre-configured panel on an electronic display, wherein the pre-configured panel comprises a static chrome area that must remain fully visible when displayed on the electronic display, the method comprising:
receiving, by one or more processors, dimensions of a panel to be displayed on the electronic display;
receiving, by one or more processors, a plurality of images to be displayed in the panel;
obtaining, by one or more processors, dimensions of each of the images;
arranging, by one or more processors, all of the images on the panel at predetermined positions on the panel that do not coincide with the static chrome area of the panel;
determining, by one or more processors, whether any portion of any of the arranged images exceeds the dimensions of the panel or coincides with any portion of the static chrome area of the panel;
scaling, by one or more processors, the images to reduce the size of all of the images by a predetermined proportional amount if it is determined that any of the arranged images exceeds the dimensions of the panel or coincides with any portion of the static chrome of the panel; and
repeating the arranging step through the scaling step until none of the arranged images exceeds the dimensions of the panel or coincides with any portion of the static chrome of the panel.

2. The method of claim 1, further comprising:
generating, by one or more processors, a set of coordinates associated with each of the respective product images and corresponding to the respective position of the respective arranged image in the panel, the set of coordinates indicating where the respective product image should be placed in the pre-configured panel when displayed on the electronic display; and
displaying, by one or more processors, the pre-configured panel and the plurality of product images with the product images anchored in the pre-configured panel at their associated coordinates.

3. The method of claim 1, further comprising:
prior to the first arranging step, scaling the images by an amount equal to a ratio of a maximum predetermined first dimension divided by a largest first dimension of the first dimensions of all of the images.

4. The method of claim 1, further comprising:
prior to the first arranging step, scaling the images if necessary to reduce all of the images to have an associated first dimension that is less than or equal to a maximum predetermined first dimension.

5. The method of claim 4, further comprising:
if all of the scaled images have an associated first dimension that is less than the maximum predetermined first dimension, scaling all of the images by an amount to increase the largest first dimension of the images to equal the maximum predetermined first dimension.

6. The method of claim 1, wherein the arranging step comprises arranging, by one or more processors, the images in a predetermined shape according to a predetermined order of image placement based on the dimensions of the images.

7. The method of claim 6, wherein the predetermined shape comprises a pyramid shape and the images are placed from the top down in order of greatest height.

8. The method of claim 7, wherein an image may be placed to overlap another image up to a predetermined percent of the other image.

9. The method of claim 8, wherein the predetermined percent is configurable.

10. At least one computer Readable storage medium tangibly embodying program instructions which, when executed by a computer, implement a method for dynamically arranging a plurality of product images in a pre-configured panel on an electronic display, wherein the pre-configured panel comprises a static chrome area that must remain fully visible when displayed on the electronic display, the method comprising:
receiving, by one or more processors, dimensions of a panel to be displayed on the electronic display;
receiving, by one or more processors, a plurality of images to be displayed in the panel;
obtaining, by one or more processors, dimensions of each of the images;
arranging, by one or more processors, all of the images on the panel at predetermined positions on the panel that do not coincide with the static chrome area of the panel;
determining, by one or more processors, whether any portion of any of the arranged images exceeds the dimensions of the panel or coincides with any portion of the static chrome area of the panel;
scaling, by one or more processors, the images to reduce the size of all of the images by a predetermined proportional amount if it is determined that any of the arranged images exceeds the dimensions of the panel or coincides with any portion of the static chrome of the panel; and
repeating the arranging step through the scaling step until none of the arranged images exceeds the dimensions of the panel or coincides with any portion of the static chrome of the panel.

11. The at least one computer readable storage medium of claim 10, further comprising:
generating, by one or more processors, a set of coordinates associated with each of the respective product images and corresponding to the respective position of the respective arranged image in the panel, the set of coordinates indicating where the respective product image should be placed in the pre-configured panel when displayed on the electronic display; and
displaying, by one or more processors, the pre-configured panel and the plurality of product images with the product images anchored in the pre-configured panel at their associated coordinates.

12. The at least one computer readable storage medium of claim 10, further comprising:
prior to the first arranging step, scaling the images by an amount equal to a ratio of a maximum predetermined first dimension divided by a largest first dimension of the first dimensions of all of the images.

13. The at least one computer readable storage medium of claim 10, further comprising:
prior to the first arranging step, scaling the images if necessary to reduce all of the images to have an associated first dimension that is less than or equal to a maximum predetermined first dimension.

14. The at least one computer readable storage medium of claim 13, further comprising:
if all of the scaled images have an associated first dimension that is less than the maximum predetermined first dimension, scaling all of the images by an amount to increase the largest first dimension of the images to equal the maximum predetermined first dimension.

15. The at least one computer readable storage medium of claim 10, wherein the arranging step comprises arranging, by one or more processors, the images in a predetermined shape according to a predetermined order of image placement based on the dimensions of the images.

16. The at least one computer readable storage medium of claim 15, wherein the predetermined shape comprises a pyramid shape and the images are placed from the top down in order of greatest height.

17. The at least one computer readable storage medium of claim 16, wherein an image may be placed to overlap another image up to a predetermined percent of the other image.

18. The at least one computer readable storage medium of claim 17, wherein the predetermined percent is configurable.

19. An apparatus for dynamically arranging a plurality of product images in a pre-configured panel on an electronic display, wherein the pre-configured panel comprises a static chrome area that must remain fully visible when displayed on the electronic display, comprising:
one or more processors which receive dimensions of a panel to be displayed on the electronic display, a plurality of images to be displayed in the panel, and dimensions of each of the images, and which arrange all of the images on the panel at predetermined positions on the panel that do not coincide with the static chrome area of the panel, determine whether any portion of any of the arranged images exceeds the dimensions of the panel or coincides with any portion of the static chrome area of the panel, and if it is determined that any of the arranged images exceeds the dimensions of the panel or coincides with any portion of the static chrome of the panel, scales the images to reduce the size of all of the images by a predetermined proportional amount, and repeats the arranging and scaling until it is determined that none of the arranged images exceeds the dimensions of the panel or coincides with any portion of the static chrome of the panel, and which further generates a set of coordinates associated with each of the respective product images and which correspond to the respective position of the respective arranged image in the panel, the set of coordinates indicating where the respective product image should be placed in the pre-configured panel when displayed on the electronic display.

20. The apparatus of claim 19, further comprising:
an electronic display which displays the pre-configured panel and the plurality of product images with the product images anchored in the pre-configured panel at their associated coordinates.
